(19) United States
(12) Patent Application Publication
(10) Pub. No.: US 2004/0205823 A1
(43) Pub. Date: Oct. 14, 2004

(54) Residential security system

(75) Inventor: James Tsai, Chung-Ho City (TW)

Correspondence Address: BACON & THOMAS, PLLC, 625 SLATERS LANE, FOURTH FLOOR, ALEXANDRIA, VA, 22314

(73) Assignee: CHIC TECHNOLOGY CORP., Chung-Ho City (TW)

(21) Appl. No.: 10/410,245

(22) Filed: Apr. 10, 2003

(51) Int. Cl. H04N 7/18

(52) U.S. Cl. 725/105; 348/143

(57) ABSTRACT

The present invention relates to a residential security system especially one of Web smart type mainly passing through the traditional PSTN (Public Switch Telephone Network) for dual-direction information control and video signal transmission. Apart from connecting to PC (System PC with WEB Server) and DVR (Digital Video Recorder) at the rear-end, the invention is also designed with several WEB cameras at the front and an individual connecting Host. A Modem is designed in the telephone wire between the PC and Host for transmission of video-signal from each Host and passing through PSTN to return to PC for live surveillance recorded by a DVR. Hence, the present invention provides a very reliable tool for alarming the police and increasing live surveillance and joint systems can also be formed to increase safety and surveillance of high-residential areas, office buildings and other important locations.

### INVENTION TECHNOLOGY

The present invention relates to a residential security system especially one of Web smart type for residential security.

### INVENTION BACKGROUND

For specified residential areas, passing through traditional telephone line to dial-up to Internet, transmission of video signal and communication techniques are easily installed and connected on-line especially for safety and monitoring of high-residential areas, office buildings, factories and other important locations.

Nowadays, SOC(System On Chip) are commonly used to drive telephone remote control of home appliances and are equipped with functions such as voice response, instruction remote-control operation or response to connector power inquires. These technical products are rather inexpensive and can be combined to network smart-type housing security system to expand safety protection function.

### Content

The present invention relates to a residential security system especially using the traditional PSTN (public Switch Telephone Network) for low price, nice product and easy assembly of remote video monitoring system specially used for safety and monitoring of high-residential areas, office buildings, factories and other important locations.

The present invention relates to a residential security system designed with distant monitoring and telephone remote functions. Further, a web camera is also installed for immediate present monitoring wherein the video image is transmitted to the computer and recorded by the digital video recorder.

### Mode for Carrying out Invention

With reference to FIG. 1 showing a view of the present invention in use, the present invention passes through the traditional PSTN (Public Switch Telephone Number) 11 for dual-direction information control and video signal transmission. Apart from connecting to PC (System PC with WEB server-personal computer with network server) 12 and DVR (Digital Video Recorder) 13 at the rear-end, the invention is also designed with several Web cameras 14 at the front and an individual connecting Host 15. A Modem 17 is designed in the telephone wire 16 between the PC 12 and the Host 15 for transmission of video signal from each Host and passing through PSTN 11 to return to PC 12 for surveillance recorded by a DVR 13. The present invention mentioned above uses the traditional phone dialing network linking route, as regard to SOC (System On Chip) which are used to drive controlling method of telephone remote controls. Apart from being combined to personal computers for control, the present invention can also be directly connected at any time by dialing any telephone linked to Host in order to proceed to setting of alarm. Hence, the present invention provides a reliable tool for alarming the police and increasing live surveillance and joint systems can also be formed to increase safety and surveillance of high-residential areas, office buildings and other important locations.

### DESCRIPTION OF DRAWINGS

FIG. 1 shows a view of the present invention in use.

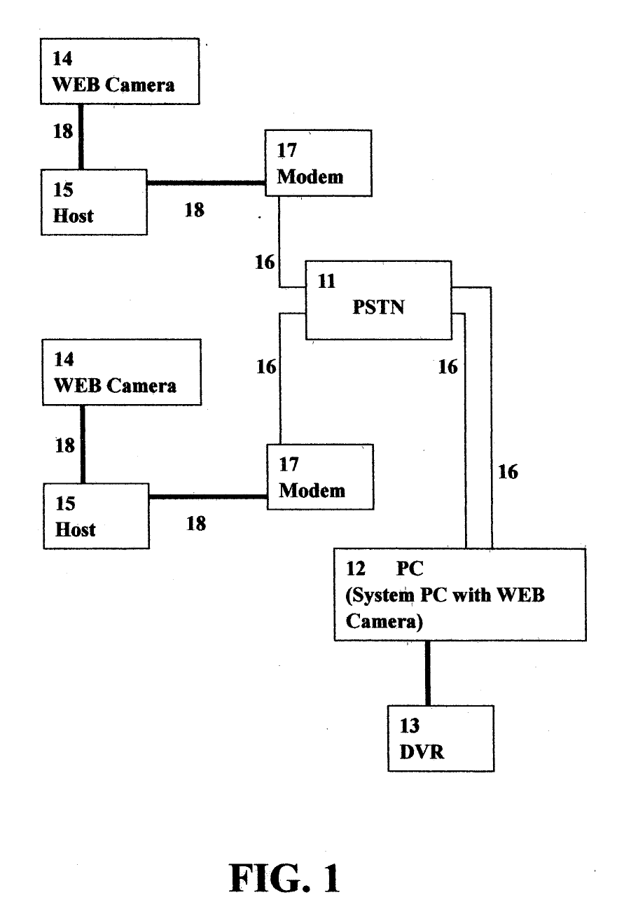

### NUMERICALS

11—PSTN (Public Switch Telephone Network)

12—PC (System PC with WEB Server)

13—DVR 14—WEB Camera 15—Host

16—Telephone wire 17—Modem 18—Internet wire

1. A kind of “Residential security system” passing through the traditional PSTN (Public Switch Telephone Network) for dual-direction information control and video signal transmission, Apart from connecting to PC (System PC with WEB Server) and DVR (Digital Video Recorder) at the rear-end, the invention is also designed with several WEB cameras at the front and an individual connecting Host. A Modem is designed in the telephone wire between the PC and Host for transmission of video signal from each Host and passing through PSTN to return to PC for live surveillance recorded by a DVR, as characterized.

2. As mentioned in claim 1 of a “Residential security system” wherein the present invention uses the traditional phone dialing network linking route, as regard to SOC (System On Chip) which are used to drive controlling method of telephone remote controls. Apart from being combined to personal computers for control, the present invention can also be directly connected at any time by dialing any telephone linked to Host in order to proceed to setting of alarm.
